(19) United States
(12) Patent Application Publication
(10) Pub. No.: US 2007/0110235 A1
(43) Pub. Date: May 17, 2007

(54) Method and system for authenticating appraisal reports

(76) Inventors: Kirk Pruitt, Irvine, CA (US); Ryan Paul Chamberlain, Trabuco Canyon, CA (US)

Correspondence Address: JEFFREY A. TRAVIS;c/o Plager Law Offices, P.C., 16152 Beach Blvd., Suite 207, Huntington Beach, CA, 92647, US

(21) Appl. No.: 11/282,205

(22) Filed: Nov. 17, 2005

(51) Int. Cl. G09C 5/00

(52) U.S. Cl. 380/54

(57) ABSTRACT

A computer implemented method for authenticating an appraisal report comprising collecting data on an appraisal document, extracting the data, encrypting the data, encoding the encrypted data into an image, affixing the image onto the appraisal document, extracting the image from the appraisal document, decrypting the encrypted data, and verifying the decrypted data on the appraisal document with the data on the appraisal document. The method further comprising an appraisal document and data in machine-readable format; extracting the data, storing the data, encrypting the data, encoding the encrypted data, affixing the image onto the appraisal document, and decrypting the encrypted data comprises a computer program; authenticating valid appraisers; and extracting the encrypted data from the appraisal comprises a scanner. The method further comprising processes making the system accessible online through a central server.

### BACKGROUND OF THE INVENTION

1. Field of the Invention

The present invention relates to a method and apparatus for authenticating and verifying the integrity of documents. More particularly, the present invention relates to a method and system for encoding data contained in an appraisal report, applying encoded data on an appraisal report, and verifying the integrity of an appraisal report with encoded data by comparing the original document to decoded data taken from an encoded appraisal report.

2. Description of Related Art

Industry Background

Although paper is an enormous asset in our economy its materiality creates an unjustified impression of trustworthiness. Paper has a history of vulnerability and is prone to fraud. Fraud relating to paper documents is a constant problem in all fields of business, and the real estate and lending fields have been no exception. Specifically, there has been an increasing amount of fraud relating to property appraisal reports.

Before a lender will lend money for the purchase of property, they first need to know the properties fair market value. It is necessary for a lender to have an unbiased, objective, professional opinion of value on a property because they typically do not lend funds in excess of certain percentages authorized by their company's established guidelines. Typically the concept of “Loan-to-Value” is used to come up with the percentages. Loan-to-Value is calculated by dividing the requested borrowed funds by the fair market value of the property used to secure a loan. To protect the lender's interest in case of default they usually require that the property be worth more, or equal to, the amount requested to borrow. By requiring the property to be worth more, or equal to, the amount requested to borrow they are trying to ensure they will not loose the amount invested or loaned.

To find out the fair market value of a property a lender usually obtains an unbiased opinion of value. It is common for lenders to use a State licensed appraiser to evaluate and give an opinion of value on a property used to secure a loan.

A real estate appraisal report is an estimated opinion of value produced by a licensed or certified appraiser. Generally, appraisal reports can include a detailed description of the subject property with an inspection, the composition of the surrounding neighborhood, market conditions and trends for the neighborhood, estimated site value with a cost approach of the dwelling, three or more recent comparable sales, income, photographs, analysis of all data, and most importantly the reconciliation which describes the emphasis in developing the final value.

To estimate the value in a federal loan transaction, appraisers who are licensed or certified, work from standard forms created by Fannie Mae with specific guidelines. The numerous appraisal forms are provided by several vendors. Once the appraisal report is completed, it is then submitted to the client or broker who holds the appraisal and other escrow documents for the lender. After all necessary documents are gathered they are then submitted to the lender who will then review the escrow package including the appraisal report. Underwriters for the lenders will frequently ask for conditions, after satisfied then will authorize or decline a loan amount for the real property.

Mortgage Fraud

Mortgage fraud has made headlines locally and nationally. Most of the time, mortgage fraud involves identity theft or fraud—making a borrower appear to be somebody else (E.g., a ‘Straw Buyer’), with a better job, more income or fewer debts. But, a lot of mortgage fraud involves a broker or loan officer telling the mortgage—the lender—and the borrower that the house is worth more than it's fair market value. In this way, they can close a larger loan and make a bigger commission. Since real estate agents usually make a percentage of the sale as commission, it is not uncommon for them to participate in mortgage fraud schemes of this nature. Although not typical of the common broker or agent, mortgage fraud of this type always originates with one of the parties who make a commission on a closed sale. Sometimes, this type of fraud is accomplished without an appraiser involved. Honest, professional appraisal reports are simply altered, or honest, professional appraiser's signatures forged. If all parties in this process work honestly, all goes well. However, the grim reality is mortgage fraud is a growing and pervasive problem in the lending and appraisal industry.

A Jul. 29, 2005 article published on Newsday.com cites a study estimating 10% of the mortgage fraud, a multi-billion dollar a year problem, is a result of fabricated or intentionally inflated appraisals. Even large mortgage companies are not immune as one was recently required to “implement a program aimed at detecting fraudulent mortgage loans.” (Orange County Register, Mar. 18, 2005)

Based on existing investigations and mortgage fraud reporting, 80 percent of all reported fraud losses involve collaboration or collusion by industry insiders. The high volume of loan transactions creates a volatile arena with many players and forms of mortgage fraud which include falsely inflating the value of the property, or issuing loans based on fictitious properties and or persons, fabricating complete appraisals, and identity theft of the real estate appraiser.

The true level of mortgage fraud is largely unknown. The mortgage industry itself does not provide estimates on total industry fraud. Standard & Poor's Structured Finance Group estimated the annual cost of mortgage fraud in 2003 at 3 basis points, or $1.2 billion, on the record-breaking $4 trillion of mortgage originations that year, according to panelist George Kimmel, associate director of the group.

An FBI report in 2005 describes mortgage fraud as “pervasive and growing.” Mortgage fraud continues to increase in the United States, with the number of suspicious activity reports to the Federal Bureau of Investigation in 2004 almost triple those in 2003, according to the report by the FBI.

Security Methods for Authenticating Appraisal Reports

Currently, there are vendors that provide standard appraisal documents with standard form fields or, field data, relating to the specifics of the appraisal. Appraisers will then fill out these forms, print them or email a digital version and send them to the broker or lender. The advent of the digital age has spawned attempts at controlling and streamlining the flow of appraisal information through online and other digital media for efficiency and speed.

U.S. Pat. No. 6,898,574 to Regan describes, in part, a method and system for an appraisal agent interfacing with a standard appraisal form, filling out these fields, stored on a central repository, and/or transmitted to the lender. (Detailed Description of the Invention, Column 10, Lines 20-60)

United States Patent Application No. 2002/0062218 issued to Pianin and United States Patent Application No. 2002/0002494 also discloses an online repository for appraisal services.

However, what is not taken into account in these applications and patent is that (1) documents are still transmitted through traditional postal mechanisms meaning that the documents must be printed. Once printing occurs, the integrity of the document is in question because paper documents can be manipulated absent some reliable means for verifying that the paper documents submitted to the lender reflect the contents of the actual appraisal; and (2) the electronic documents can be altered subsequent to their creation date and changed for fraudulent purposes.

The real estate and lending industry typically require appraisal reports of all types to be sent in a digital format. Digital delivery of documents provides numerous benefits to both the sender and receiving parties, primarily time and money. Underwriters can process the digital information into their software and other required formats without retyping any portion of the text.

Typical delivery methods for appraisals are in the form of a digitally secured document (e.g., .pdf, .tiff) which has been proven to provide little or no protection from tampering. In large part due to recent software technologies that can convert these formatted documents into other, alterable documents. Further, the use of scanners can transform the paper document to digital form for manipulation. Thus, an appraiser sending unsecured digital reports using today's standards can not guarantee the integrity, reliability, and accuracy of their final paper product.

Digital Confirmations

Aside from authenticating the appraisal document itself, there are also well-known methods for digitally ensuring that the electronic exchange of documents is secure. (Digital Certificates, Digital Signatures and their attending standards) However, because the fraud the present invention is seeking to protect is the alteration of existing appraisal reports, these methods do not address this problem because they inherently assume the integrity of the documents being transmitted.

For example, United Stats Patent Application No. 2001/0002485 issued to Bisbee provides a method for handling storing electronic objects by validating digital signature, testing the method of transfer and then giving each object a unique digital signature and further means for authentication.

The problem is that for true security purposes in verifying the integrity of the data on the document itself, the encryption must be based on field data, or, data comprised of selected, relevant fields on the appraisal report identifying pertinent aspects of the appraisal and not necessarily on verification of the sender. More problematic for the appraisal industry is not so much whether appraisal reports are intercepted and altered but it is guaranteeing that the appraisal reports themselves are valid to begin with.

Linear Barcode Technology

Barcodes are an assembly of black and white lines, usually vertical, that are symbolic or, code, for numbers and letters. Barcodes can be read using laser beams to distinguish the width and placement of the black and white bars on labels. (e.g., UPC labels) The conception of bar coding appeared more than 30 years ago and is now found on many products in various industries.

However, conventional barcodes have some inherent limitations. They require precise, high-contrast printing, typically on labels, in order to be read reliably because they encode information in an analog fashion in the form of alternating bars and spaces of varying widths making them difficult and costly to duplicate on paper. Linear barcodes, therefore, have been largely commercially unviable on a larger scale than their current status because of the types of equipment needed to print and read them.

Further, barcodes have been used for assigning a unique identification number using known encryption standards.

Consider Unites States Patent Application No. 2005/0038756 issued to Nagel or 2005/0038754 issued to Geist where both use a non-deterministic (not unique or determined by the document) identification in the form of a barcode affixed to a document to verify the authenticity of that document. Although this will provide a small measure of protection for appraisal reports, it has not been done. Further, even a barcode with a unique identification number, encrypted or otherwise, only confirms that it is the right appraisal and not that the data contained in the appraisal is right because only an appraisal encryption with deterministic characteristics (i.e., data determined by the document itself) will do this.

PDF417 Barcode Technology (2D)

PDF417 is a 2-dimensional barcode used in a variety of applications. It is best suited for cases where information needs to move with an item or document. PDF417 is a stacked or, layered, barcode symbology, comprising code words, or individual barcodes, arranged in rows and columns. This allows a large amount of data to be encoded in a single symbol. PDF417 also utilizes Reed-Solomon error correction routines, enabling damaged symbols to be reconstructed. The symbology is capable of encoding the entire (255 character) ASCII set as well as 2725 data characters in a single barcode.

The PDF417 format was developed by Symbol Technologies. Today, open source encoders and decoders are freely available for integration into applications. Unfortunately, like linear barcodes, the PDF417 symbol can only be read with specialized handheld lasers or scanners and require sophisticated printers to print out the symbol.

DataMatrix (2D)

Data Matrix is the most popular 2-D symbology which has found use in automotive, aerospace, electronics, medical devices and other manufacturing unit-level traceability applications. Data Matrix codes are typically not replacing conventional barcodes in their applications but instead are extending barcode applicability to areas where they have not been applied in the past. Data Matrix symbology has been placed in the public domain so that anyone can print or read Data Matrix codes without paying a license. A variety of standard setting bodies around the world have issued standards regarding the use of Data Matrix symbology for a variety of applications. Further, like PDF417 technology, open source encoders and decoders are also freely available for integration into applications like that of the present invention.

Until recently scanning and decoding of 2D symbology was a challenge. First, linear barcode scanners,—those ones you can see in stores and supermarkets,—could not be used to read 2D-symbols because they read the symbol only in one direction. Second, cheap and high performance hardware platforms did not exist until now and they were not able to decode 2D symbology. Both problems have now been resolved because processors have enough processing power, sophisticated digital cameras are now commercially available and can be connected to hardware through standard high-speed interfaces. (E.g., USB ports) Thus, hardware is now easily available that is capable of decoding 2D barcodes. With newer technologies, field data used in standard forms for such things as appraisals, can now be encrypted, compressed, stored in machine-readable images, and decrypted all using hardware found in most offices.

With the increasing mortgage fraud and security needs of those who base their lending amount on these reports, there is a need for current technologies to provide a measure of security and authentication for appraisal reports by utilizing proprietary or open source technologies to create a software program that can authenticate a document with an encryption method capable of being affixed to a paper document and whose encryption encompasses deterministic characteristics of that document.

### SUMMARY OF THE INVENTION

Accordingly, one object of the present invention is to provide a method and apparatus capable of securing the integrity of appraisal reports.

A second object of the invention is to provide a software implemented method for authenticating an appraisal report whereby field data is extracted from an appraisal document; encoded into an image; affixed onto an appraisal document; the image gets extracted and decoded from the appraisal document and then the decrypted field data on the appraisal document is verified with the field data on the appraisal document.

A third object of the present invention is to provide a software implemented method for authenticating appraisal reports whereby field data is extracted and then encrypted before being encoded.

A fifth object of the present invention is to provide a software implemented method for authenticating appraisal reports whereby valid or active appraisers are verified before they can authenticate appraisal reports.

A sixth object of the present invention is to provide a software implemented method for authenticating appraisal reports online.

A seventh object of the present invention is to provide a software implemented method for authenticating appraisal reports through the use of a DataMatrix image using deterministic data.

A eighth object of the present invention is to provide a software implemented method for authenticating appraisal reports through the use of a standard barcode image using deterministic or non-deterministic data.

A ninth object of the present invention is to provide a software implemented method for authenticating appraisal reports through the use of a standard barcode image using deterministic or non-deterministic data.

A tenth object of the present invention is to provide a software implemented method for authenticating appraisal reports through the use of a standard barcode or DataMatrix image using deterministic or non-deterministic data and capable of being scanned.

An eleventh object of the present invention is to provide a software implemented method for authenticating appraisal reports through the use of an appraiser client program to create an authenticated appraisal report and a lender client program to scan and verify an authenticated appraisal report.

### BRIEF DESCRIPTION OF THE DRAWINGS

FIG. 1 is an exemplary block diagram of an overview of the appraisal authentication method.

FIG. 2 is an exemplary block diagram illustrating the configuration of appraisal authentication by an active appraiser.

FIG. 3 is an exemplary embodiment illustrating the logical flow for encoding encrypted field data into images written onto appraisal reports.

FIG. 4 is an exemplary embodiment illustrating the method for decoding field data from encoded images on appraisal forms.

FIG. 5 is an exemplary embodiment of a block diagram illustrating implementation of the present invention online from a central server.

FIG. 6 is a block diagram illustrating the steps for authenticating active and inactive appraisers through online processes.

FIG. 7 is a block diagram illustrating the steps taken by a lender after receipt of the appraisal report with the encoded image.

FIG. 8 is an exemplary block diagram showing an exemplary embodiment for extracting and encoding deterministic data from an appraisal report.

FIG. 9 shows a sample appraisal report cover sheet without an encoded image.

FIG. 10 shows a sample appraisal form cover sheet with an encrypted image.

FIG. 11 is an appraisal client software dialog screen with selected client inputs for creating encrypted data into an encrypted image.

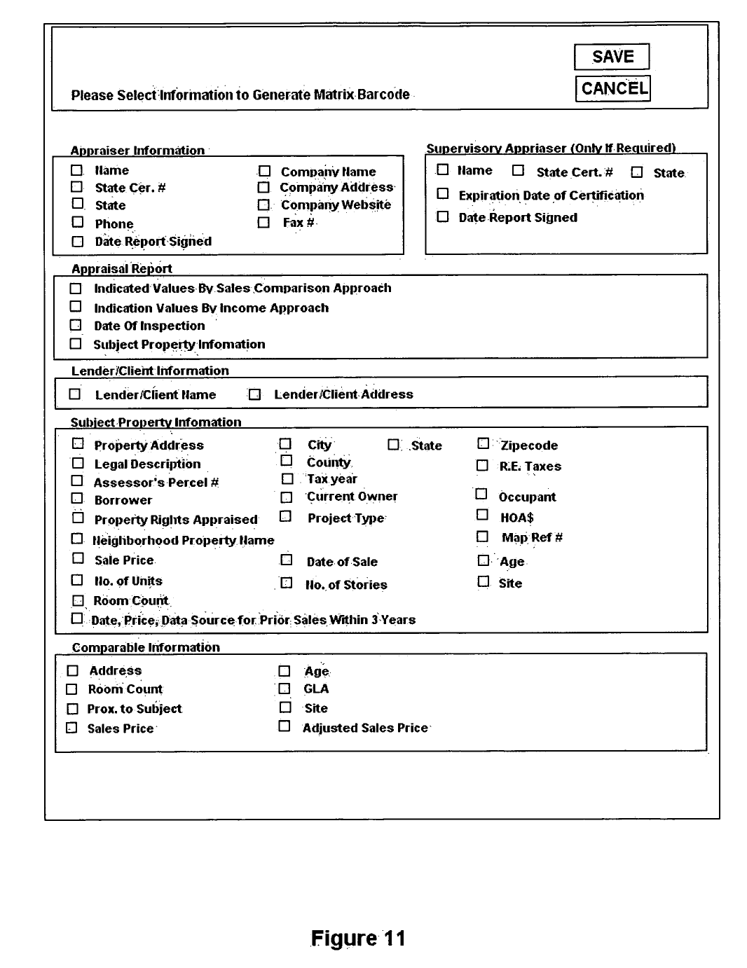

FIG. 12 is a client software dialog for authenticating appraiser information.

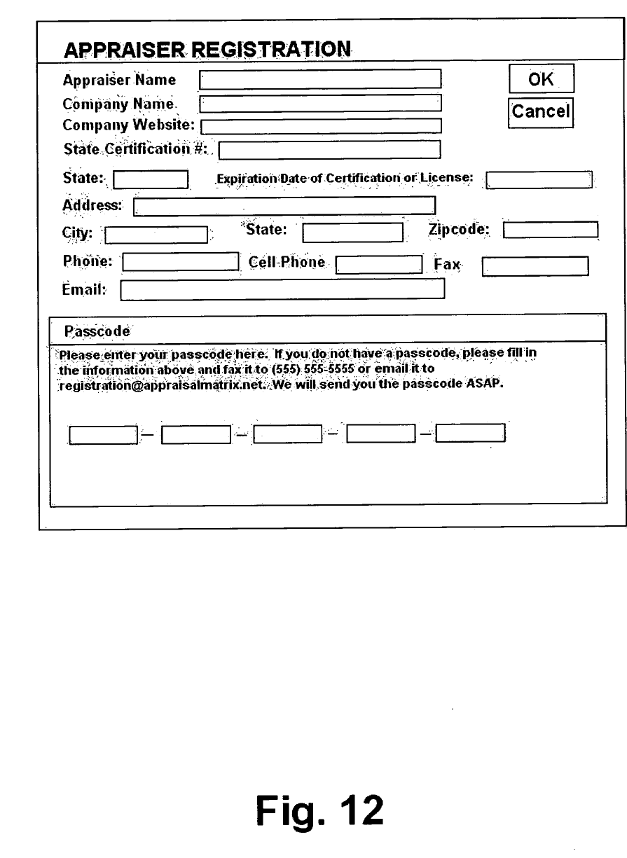

FIG. 13 is a lender client software dialog screen with selected inputs and display information.

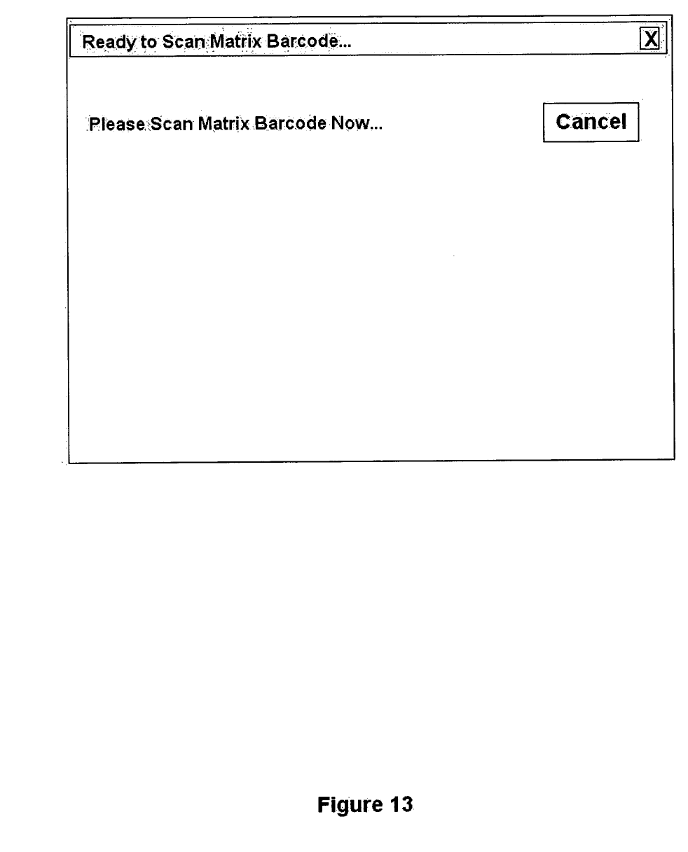

### DETAILED DESCRIPTION OF THE DRAWINGS AND PREFERRED EMBODIMENTS

A thorough understanding of this invention can be gained through reference to the drawings in conjunction with a complete review of the disclosure herein.

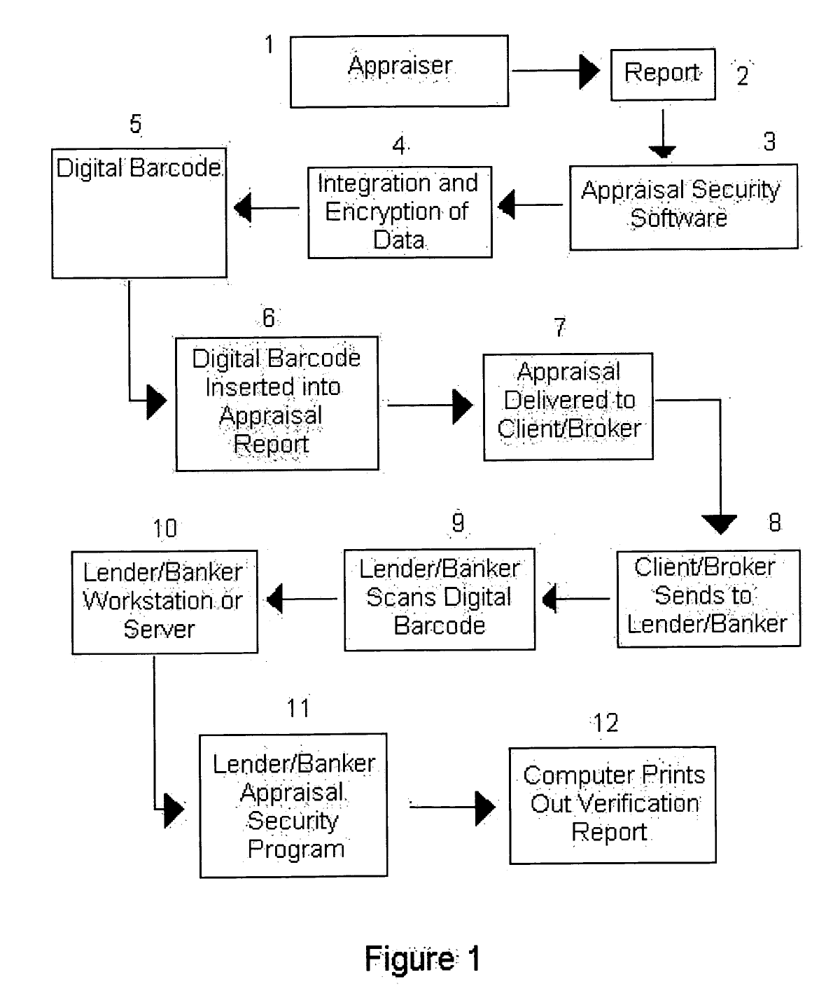

FIG. 1 is an overview showing an exemplary diagram of the present invention's appraisal authentication method. An active appraiser 1 with a unique identification completes an appraisal report 2 using a standard appraisal report or form 2. The report 2—typically a digital file with extractable data—is usually stored on a workstation or server 4 where a software program 3 (In general referred to as ‘AppraisalMatrix’) is installed that can extract specified field data from selected fields on the report 2, encrypt 4 it using known encryption software, and then creating a digital barcode or image 5 using known technology for creating, preferably, compressed deterministic data taken from the appraisal report 2. (For purposes of this application, barcode or image can are used interchangeably)

The software program or method then applies or inserts 6 the digital barcode or image 5 onto the appraisal report 2 which is then delivered 7—either through digital or traditional postal delivery mechanisms—to the client, broker, lender or other intended recipient.

At this point, the lender (typically, this action will be performed by the lender since they are the one that must verify the data) scans 9 the digital barcode or image with a standard, known barcode scanner with corresponding software, hardware, or firmware that interfaces with the software of the present invention. The encrypted data is transferred from the image or barcode to the lender workstation, computer 10, or other designated download location where decryption software 11 of the present invention has been installed. The decryption software 11 then decrypts the transferred data and displays it in a verification report or verification form 12 that can be reviewed either digitally or in printed form thereby enabling the lender to compare the contents of the fields of the verification report with either the digital or printed copy of the appraisal report.

Active Appraisers

To ensure the integrity of the present invention, requiring all appraisers using the software to be “active” is preferred. An active appraiser 1 is one who is certified or licensed by a U.S. State, the federal government, territory or possession to perform appraisals and whose status can be verified through an active appraiser's database. Appraisers' databases are either federal, (E.g., the Appraisal Subcommittee or ASC) or can be created by state or other private entities who have access to this data. Currently, these databases can be accessed either online or are made available to private vendors who may need to use them to validate certified appraisers through their software. For purposes of the present invention, active appraisers can be accessed through an online database, a central database, or through an updated database distributed with and accessible by the software of the present invention. In this preferred embodiment, only active appraisers are permitted to perform appraisals and they typically use standard form appraisals distributed by various software vendors.

Appraisal Forms

Once the status of an appraiser is ascertained, the present invention allows appraisers to utilize standard appraisal report forms 2 used in appraisals for mortgage loan transactions. Vendors that utilize these forms are well known in the field as is their software that includes Nova from Day One, Rapid Report from ACI, Appraise-It from SFREP, WinTOTAL from A La Mode, Toolbox from Bradford, and others.

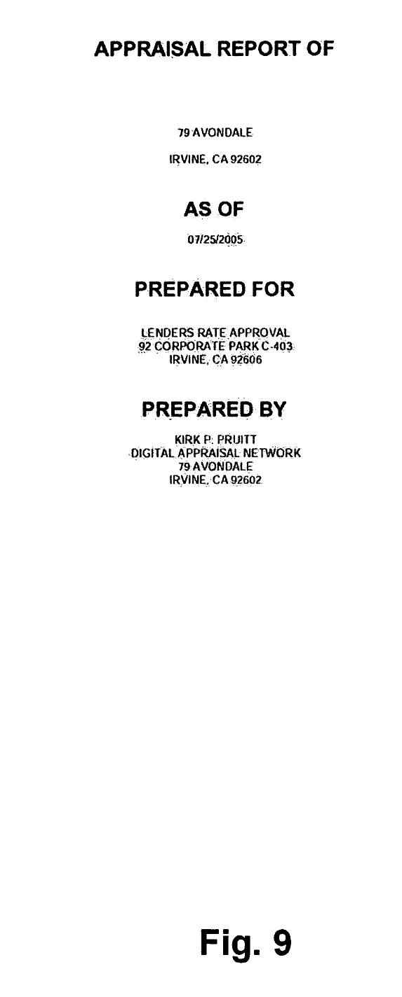

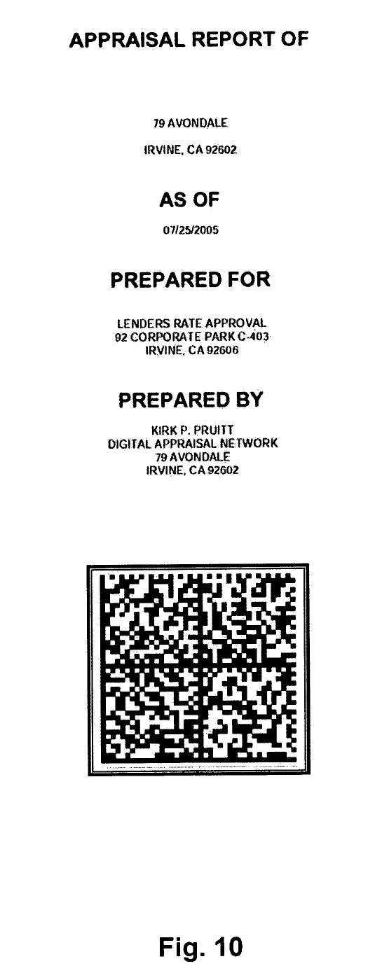

FIGS. 9a through 9c are illustrative of a standard appraisal form cover sheet without an encrypted image affixed to it. FIGS. 10a through 10c show a standard appraisal form cover sheet with an encrypted image on the front and a page on the appraisal. FIG. 10c, contains an addendum referencing the encrypted data for lenders who have downloaded or printed out the appraisal. On the appraisal are selected fields into which appraisal data are inserted. Presently, most of the appraisal reports are delivered in electronic format. (E.g., Acrobat PDF, Microsoft Word, Tiff, and etc.) Yet, many are still delivered via paper. Standard form vendors like those listed above partner with companies that want to create add-on components and features to their digital form software. To do this, they supply relevant API's or other software interfaces where software, like the present invention, can extract the field data from the appraisal report and manipulate that data to their own ends.

The present invention can integrate with standard vendor appraisal forms and provide the functionality to secure the appraisal report data by encoding & encrypting extracted appraisal data with known barcode or other 2 dimensional encryption algorithms. The method for enabling software to authenticate appraisals contains three major components: Configuration, Encoding, & Decoding.

Appraisal Authentication

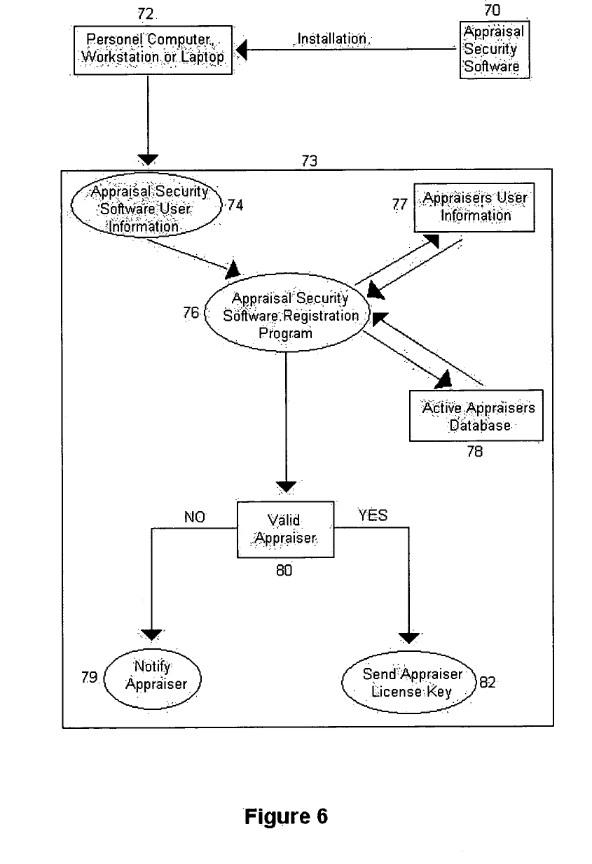

In a preferred embodiment, before a user/appraiser can use the software incorporating the present invention, they first need to be authenticated as a valid or active appraiser. In a preferred embodiment authentication occurs as an online validation process as illustrated in FIG. 6.

In the embodiment for online validation a user installs the AppraisalMatrix software 70 on their workstation or server 72 that, once installed, prompts for a license key that can be obtained from the AppraisalMatrix server 73. To access the server 73, the appraiser client can go online to the AppraisalMatrix or other website where they enter in information 74 through dialog boxes or other web forms prompted by the server and incorporating known methods for filling out identifying information online.

Alternatively, the appraisal software 70 can also make available means for storing appraiser user information and, once the user goes online to obtain the license key, the software 70 can incorporate known means for passing this information to the server 73 so that the appraiser does not have to fill out the information online.

The registration information, including identifying information about the appraiser, is then stored in an internal AppraisalMatrix database 77; and a registration program 76 authenticates the appraiser by retrieving the appraiser's registration information from a database 77 storing the appraiser identification information; retrieving the appraiser's credential from an active appraiser's database 78; and then processing the registration by checking that the appraiser identified in the registration information is valid or active 80.

If the appraiser's credential is valid or active when queried against the appraiser's database, then that appraiser will be sent a license key 82 or making that key available through known means such as sending through email an encrypted key to be used by the appraiser in obtaining the license information from a secure or authenticated server containing the license.

Otherwise, the appraiser using the software 70 will be notified that their appraiser status is invalid 79 and will not be sent a license key but can also send other information notifying them of the invalidity and other information needed to update their credentials in the appraiser's database 78.

Although what has been described for authentication is preferred and can be accomplished through known programming and networking techniques, other methods of authentication can include a designated employee or person making a manual comparison of entered information against any variation of an appraiser database whether electronic or printed.

Further, registration as it has been disclosed here encompasses other known techniques such as through email, or, for those who do not have access to online communication verbal validation over a phone line or through traditional postal methods. In this way, the appraiser can obtain the required key and enter it into the program 70 on their workstation or server.

Appraisal Configuration

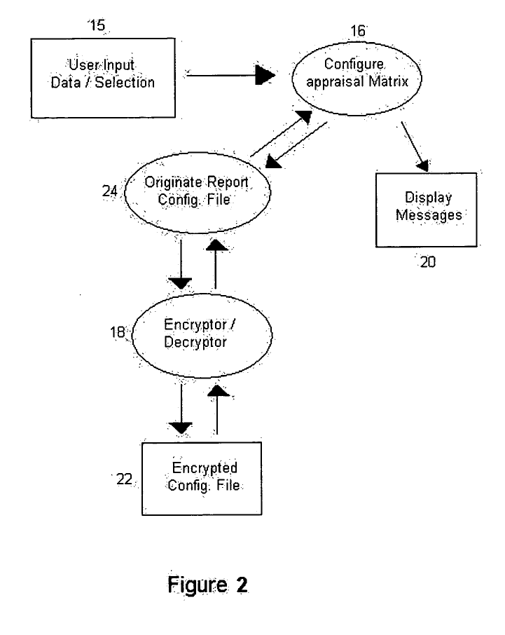

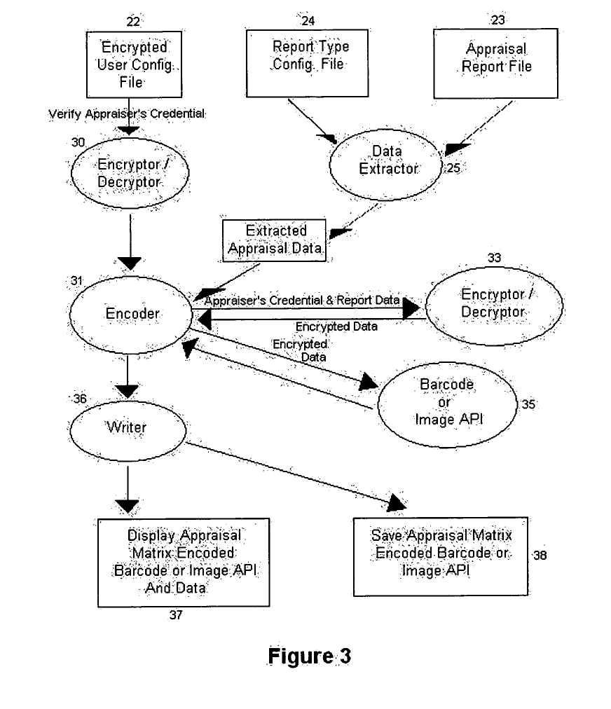

To begin the appraisal authentication, a user must first configure specified field data from the appraisal form using the software 3 referenced in FIG. 1. Once the appraiser/user has been authenticated, a preferred embodiment shown in FIGS. 2 and 3 requires the appraiser to configure the appraisal report 16 by selecting specified data fields in the appraisal report 23 that will later be extracted 25 and then encoded 31.

The data extractor function 25 is executed and pulls the selected field data from the appraisal report file 23 and creates a separate appraisal configuration (“config”) file 24 in a usable file type containing the specified field data in unencrypted form.

Standard form appraisal documents and the vendors that supply them also supply the necessary code and other information to add-on software partners to accomplish these types of actions or functions. Additional data can therefore be added using known programming techniques for the data extractor 25 where, in addition to the field data on the appraisal form 23, other data, such as appraiser identification that can assist in making the configuration data for the configuration file 24 unique is selected 15 from which the unencrypted report configuration file 24 is created and configured 16, encrypted 18, and then encoded 31.

Once the fields and other data have been selected, displayed 20, and approved by the appraiser, an encrypted config file 22 is generated from the unencrypted config file 24 by an encryption program 33 during the encoding process 31. Alternatively, encryption of the unencrypted config file 24 can occur in a process separate from and before the encoding process 31. The encryption algorithm can be any known and accepted in the art such as symmetrical encryption or asymmetrical encryption using 128 bit or more hashing algorithms for optimal security. Further, encryption of the unencrypted config file 24, although preferred is also not necessary to the implementation of the present invention but does provide an extra layer of security on the appraisal verification method so that the data when later scanned from the document cannot be altered except by the key installed with the lender client software.

FIG. 3 details the encoding process. Once an encrypted config file 22 is created, an encoder 31 generates a barcode or image from the data in the encrypted config file 22. This is accomplished by making Application Programming Interface or “API” calls 35 to a desired digital or barcode encoding algorithm. A preferred embodiment is to use publicly available technology from DataMatrix that encodes information digitally in the form of a checkerboard image comprised of on/off cells. FIG. 10a shows a DataMatrix image digitally attached to a standard appraisal form. However, other technologies such as those described in the Description of Related Art can be used although it is preferred that they are capable of encoding deterministic field data in addition to non-deterministic data into the barcode or image. Although non-deterministic data can be used as a security mechanism for validating an appraisal document and has not yet been done, incorporating deterministic data authenticates the document AND the contents of that document. Encoding non-determined data as an implementation of the method previously described is one embodiment that can be inferred herein even though it does not provide the same layer of protection provided by using determined data.

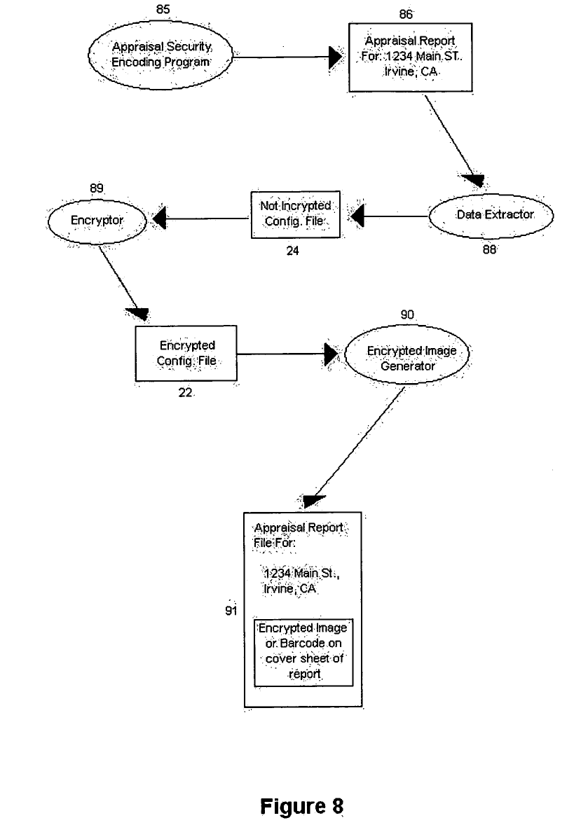

Extracting and encoding deterministic data from the appraisal report is shown in FIG. 8 and accomplished by identifying select fields on the appraisal document 86; extracting that field data 88; creating a config file with the extracted data 24; encrypting that data 89 with, preferably, a public key algorithm thereby creating a new encrypted file 22; and creating a barcode or image from the encrypted data using an encrypted image generator 90 with known barcode or encrypted image technologies.

The barcode or image can be saved and stored by appraisal program 85 as a jpeg or other usable image file and then affixing that image digitally copying it to the appraisal report 91. In one possible embodiment that adds protection to this method, a written addendum to the appraisal report as is shown in FIG. 10c can be added as a notification to the lender that an encrypted image has been applied. If the addendum is there and the appraisal report is devoid of an encrypted image, this is a warning to the lender that the document has been altered through the removal of a verifying barcode or image.

Decryption

The encrypted digital barcode or image on the appraisal report 91 can then be sent through known electronic communications, traditional postal carriers, or downloaded from a central site, to a lender to initiate decoding and validation of the document.

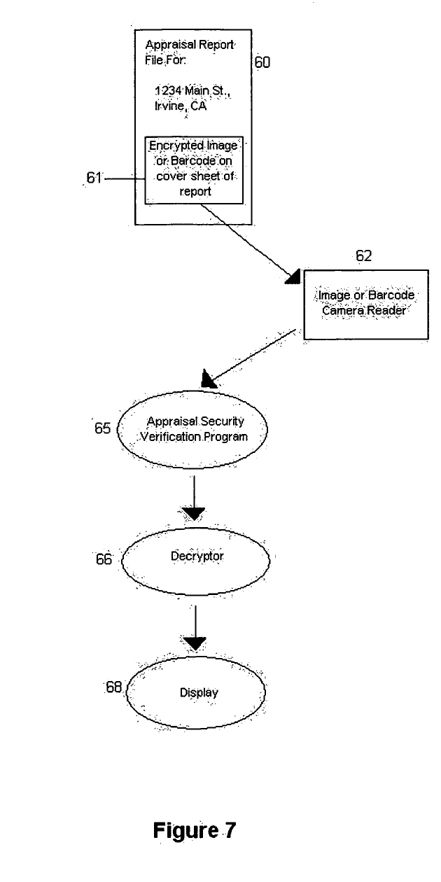

FIG. 7 is a block diagrams illustrating this process where the transmitted and printed appraisal report 91 with an encrypted image with deterministic data 61 is scanned 62, and is captured as standard input by a terminal, workstation, or server and then parsed by decoding 65 and decryption 66 programs or programs and then displayed or printed 68 for comparison and verification by the lender. It should be noted that, here, decoding and decryption is meant to illustrate two programs executing as separate threads but incorporated into one main program. The variations on the sequence are varied and those in the field will be able to see the variations that can be made to this sequence.

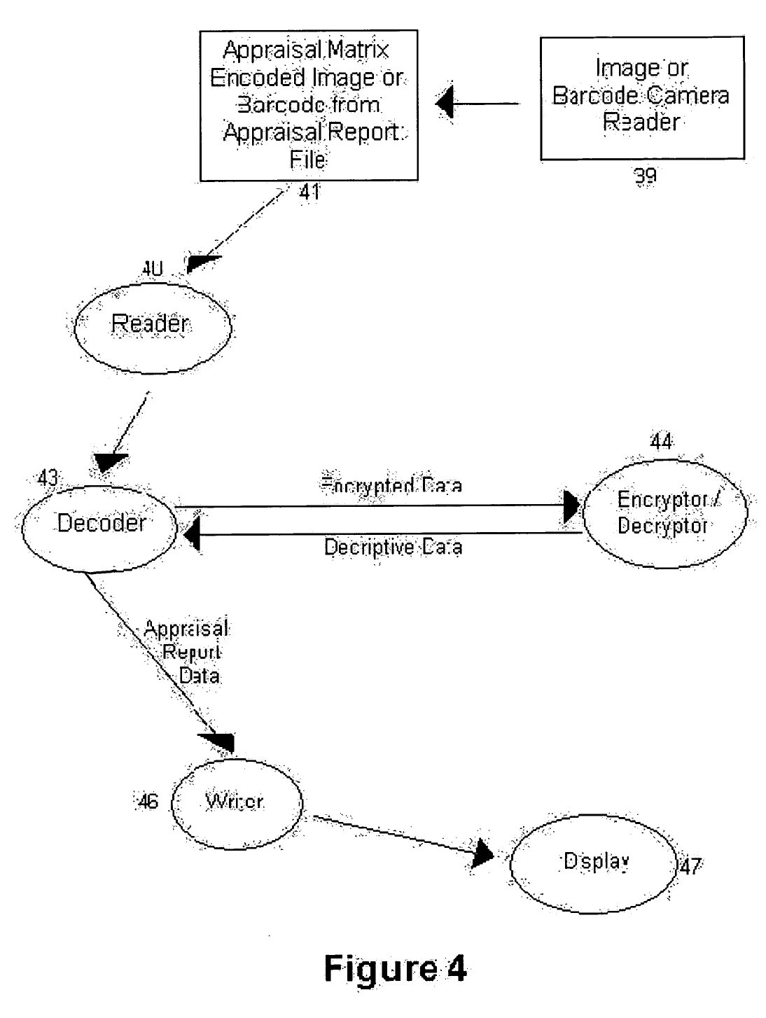

Standard scanners interpret the barcode or image and return it as an ASCII text file 64 where it can be parsed by the decoding program 65. FIG. 4 is illustrative of a detailed preferred embodiment for implementing this process.

First a lender or, any party needing to validate the contents of the appraisal, receives the printed or digital version of the appraisal report from a client/broker or other party. Next, the lender scans 39 the barcode or image with the encoded and encrypted data from the appraisal report. Typical scanners capable of performing this function are provided by a wide variety of known vendors in the field and are readily available in the art. Scanners can include traditional hand-held or stationary scanners or even newer scanning techniques contained in mobile or other devices.

Scanned data typically takes the form of a file 41 containing ASCII text of the encrypted data, which can then be interpreted using known programming techniques by other proprietary software—in this case, that of the present invention.

Here, a reader 40 programming function is used by the present invention to interpret the data on the scanned report file 41. A decoder 43 then decrypts the encrypted message in the report file 41 and writes it 46 into readable form on a known file type (.txt, .pdf, .doc, and etc) capable of being displayed 47 or printed. New technologies make printing barcodes or images less complicated and so in a preferred embodiment using such technologies such as DataMatrix, the lender will not need to make extra expenditures for new hardware to support specialized printing. A lender or other client will then be able to print a verification report 12 (FIG. 1) containing the decrypted field data and compare it to the appraisal report 2 initially authored by the appraiser.

Online Implementation

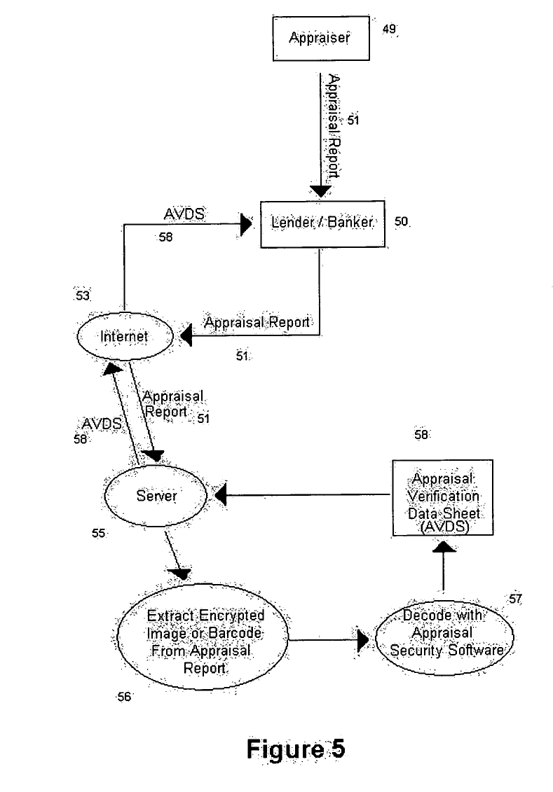

In general, the above-described preferred method can be implemented in several different ways. First, standalone software containing all the necessary steps for configuration, encryption, encoding, and verification can be installed on the appraiser and lender workstations or servers; second, the steps for effecting the appraisal authentication can be separated into logical steps for both the appraiser and the lender thus, comprising two software pieces with different functionality installed separately for each; third, all necessary steps can be incorporated on a central server accessible by appraiser and lenders through online processes as is shown in FIG. 5; or a combination of the above can be implemented.

FIG. 5 illustrates through a block diagram one embodiment of the present invention where an appraiser 49 submits to a lender 50 through traditional or electronic means, an appraisal report 51. After authentication by the lender 50 to the web server 55 using known authentication protocols the lender 50 then submits the same appraisal report a web server 55 that incorporates software 57 for decoding the appraisal report 51. The appraisal report 51 is first scanned 56—programmatically or through a standard scanner—through services provided by the web server provider and then decoded with decoding software 57. The decoded information is then packaged as an appraisal verification data sheet 58 in printed or electronic form and then sent back to the lender 50 where they can verify the accuracy of the information entered on the appraisal report 51. Here, the appraisal verification data sheet 58 is shown being sent back through online communication channels although traditional methods such as postal communications could also be used.

In another embodiment not illustrated, occurs where standard forms are made available online from the web server to an appraiser client. Furthermore, an updated appraisers database is persistently connected to either a logon or other authentication process on a web server so as to ensure only active appraisers are creating appraisals. Active appraiser authentication and verification can take the same form as described above whereby database queries to an appraiser database by the information entered by the appraiser client are compared against active/inactive appraisers on the online database. If the query returns a valid or active state, then the appraiser is authenticated and is allowed to continue with configuring the appraisal report and image.

Configuring, encoding, and decrypting in this wholly online embodiment can be accomplished in the same way as on a standalone workstation or server however, in this embodiment, the form and barcode or image attached to the form can be stored online, downloaded, or printed from the central server. The benefits for implementing the present invention in this way are many: the service is accessible from anywhere in the world; the service is subscription based as opposed to license-based and no client software is needed; instant updates are possible to accommodate for changing statutes and rules related to appraisers and lenders; the need for scanning hardware is eliminated; security is confined to authentication to the server by an appraiser; and an appraisers' database is persistently connected and updated.

In the wholly online embodiment, the logon method for accessing a central sever can incorporate known methods for authenticating online users to a central web server. This can preferably include the use of digital certificates and certificate authorities (E.g., Thwarte, Inc., Verisign) confirming that each computer is trusted by the other and providing public keys such as SSL (Secure Socket Layer) using the Transport Layer Security Protocol (TLS). Other known methods are available but the described and preferred method and other methods are helpful in obtaining greater security for online access but are not necessary to an understanding of the present invention.

Further, the preferred method for verifying active appraiser status is through an accessible central appraisal database with a persistent connection to a web server. In this embodiment, the active status of each appraiser is dynamically updated thereby increasing the chance that inactive appraisers are unable to access and create appraisals with fraudulent information.

Similar to an installable, standalone version of the present invention, standard online web forms are made available online and accessible by authenticated users/active appraisers. Also in this embodiment, the standard forms are web-accessible and the software of the present invention installed on the web server can incorporate known methods for filling out the web forms online and for executing processes previously detailed for the present invention for configuring, encrypting, encoding, decrypting, decoding, and displaying and printing verification reports.

### CONCLUSION, RAMIFICATIONS, AND SCOPE

While the above description contains many specific embodiments, these should not be construed as limitations on the scope of the invention, but as exemplifications of the presently preferred embodiments thereof. Many other ramifications and variations are possible within the teaching of the invention.

Thus the scope of the invention should be determined by the appended claims and their legal equivalents, and not solely by the examples given.

1. A software implemented method for authenticating an appraisal report comprising:
extracting data from an appraisal document;
encoding the data into an image;
affixing the image onto the appraisal document;
extracting the image from the appraisal document;
decoding the encoded data; and
verifying that the decoded data is the same as the data on the appraisal document.

2. The method of claim 1 wherein:
the appraisal document and the data are in machine-readable format;
the method further comprises a means for authenticating valid appraisers
encoding the data further comprises means for encrypting the data;
extracting the encrypted data from the appraisal document comprises scanning means; and
decoding the encoded data further comprises means for decrypting the encrypted data.

3. The method of claim 2 wherein authenticating valid appraisers further comprises prompting one or more appraisers for identifying information, one or more appraisers entering identifying information, comparing the identifying information with valid appraisers in an appraiser's database, and granting or denying access to encode or decode an image on the appraisal document based on the status of the appraiser.

4. The method of claim 3 wherein all steps for performing the method are performed online.

5. The method of claim 1 wherein encoding the data into an image comprises means for encoding the data into a DataMatrix image.

6. A computer implemented system for authenticating appraisal reports comprising:
a computer with memory, data storage, and a processor;
software means for extracting data from an appraisal document;
software means for encoding the data into an image;
software means for affixing the image onto the appraisal document;
means for extracting the encoded data from the image on the appraisal document;
software means for decoding the encoded data; and
means for verifying that the decoded data is the same as the data on the appraisal document.

7. The system of claim 6 wherein:
the appraisal document and the data are in machine-readable format;
the system further comprises means for authenticating valid appraisers;
the means for encoding the data further comprises means for encrypting the data;
the means for extracting the encoded data from the appraisal document comprises scanning means operatively linked to the computer system capable of scanning the contents of the image on the appraisal document to the computer; and
the software means for decoding the data further comprises means for decrypting the encrypted data.

8. The system of claim 7 wherein the means for authenticating valid appraisers comprises a computer program prompting an appraiser for their appraiser information, and the appraiser entering identifying information to the computer program; and the software program further having means for comparing the identifying information with valid or invalid appraisers in an appraisers database, and granting or denying access to the software program if the appraiser status is valid, or denying access to the software program if the appraiser status in invalid.

9. The system of claim 8 wherein the system for authenticating appraisal documents is accessible online.

10. The computer-implemented method of claim 6 wherein:
the appraisal document and the data are in machine-readable format;
the method further comprises means for authenticating valid appraisers by an appraiser entering identifying information online on a central server with means for comparing the identifying information entered by the appraiser against an appraisers database with valid and invalid appraisers and granting access only to valid appraisers.
encoding the data further comprises means for encrypting the data; and
extracting the data from the appraisal document, encrypting the data, encoding the encrypted data into an image, affixing the image onto the appraisal document;
and decoding the encoded data comprises a computer program accessible online from the central server.

11. The computer-implemented method of claim 6 wherein the computer program encodes the encrypted field data into a DataMatrix image.

12. the system of claim 6 wherein:
the computer system comprises an appraiser computer and a lender computer;
extracting the data from the appraisal document further comprises means for encrypting the data,
decoding the data further comprises means for decrypting the encoded data;
extracting the data from the appraisal document, encoding the data, affixing the image onto the appraisal document comprises an appraiser client computer program accessible from the appraiser computer;
extracting the encoded data from the image on the appraisal document comprises scanning means operatively connected to the lender computer; and
decoding the data comprises a lender computer program on accessible from the lender computer.

13. the method of claim 1 wherein:
the method further comprises access to an appraiser and lender computer system,
encoding the data into an image further comprises means for encrypting the data;
decoding the encoded data from the appraisal document further comprises means for decrypting the encrypted data;
extracting the data, encoding the data into an image, and affixing the image onto the appraisal document comprises a first computer program accessible from the appraiser computer system;
extracting the image from the appraisal document comprises scanning the appraisal document with scanning means; and
decoding the encoded data, comprises a second computer program accessible from the lender computer system.

14. The computer-implemented method of claim 6 wherein the computer program encodes the encrypted field data into a 2-D barcode image.
